(19) United States
(12) Patent Application Publication
(10) Pub. No.: US 2004/0194087 A1
(43) Pub. Date: Sep. 30, 2004

(54) Batch processing of requests in a data processing network

(75) Inventors: Bishop Chapman Brock, Coupland, TX (US); Elmootazbellah Nabil Elnozahy, Austin, TX (US); thomas Walter Keller, JR., Austin, TX (US); Ramakrishnan Rajamony, Austin, TX (US); Freeman Leigh Rawson III, Austin, TX (US)

Correspondence Address: LALLY & LALLY LLP, PO BOX 684749, AUSTIN, TX, 78768-4749, US

(73) Assignee: International Business Machines Corporation, Armonk, NY (US)

(21) Appl. No.: 10/121,531

(22) Filed: Apr. 11, 2002

(51) Int. Cl. G06F 9/00; G06F 9/46

(52) U.S. Cl. 718/100

(57) ABSTRACT

A method and system in which client requests to a multi-server, local area network (server cluster) are accumulated during discrete time intervals (batching periods), but not processed immediately. The servers are initialized to a low power state. At the end of a batching period or upon occurrence of some other specified event, the server cluster selects one or more servers to process the accumulated requests. The selected servers are then powered on and the requests are distributed to the powered servers for processing and response generation. After all requests have been responded to, the server cluster typically powers down the servers such that servers are actively powered only during the periods when batched requests are being processed. During times when a server cluster's request loading is sufficiently light, the response periods will be significantly shorter than the batching periods. In this case, power consumption is reduced because the servers are fully powered only during the relatively short response periods. The server cluster typically includes a router or other suitable switching device that is capable of storing requests gathered during the batching periods and of distributing the requests to the selected servers after a batching period ends. Batching periods may terminate at the expiration of a specified duration or when the age of a pending request exceeds some predetermined level of responsiveness to which the server cluster adheres.

### BACKGROUND

1. Field of the Present Invention

The present invention generally relates to the field of data processing networks and more particularly to a network and method for conserving power by batching requests while maintaining servers in a low power mode and dispersing the batched requests thereafter.

2. History of Related Art

In the field of data processing networks and, more particularly, data center environments, energy management is now necessary for commercial, technical, and environmental reasons. For purposes of this disclosure, a data center refers generally to a group of data processing systems that are interconnected to provide a common service to clients. In a data center, the data processing systems are typically server class systems physically located within close proximity to each other. Data centers may deploy hundreds or thousands of servers, densely packed to maximize floor space utilization. Deploying servers in this manner pushes the limits of power delivery and heat dissipation systems. Energy consumption and cooling costs are now significant factors in the cost of operating a large data center. In addition, densely packed server clusters tend to experience a high rate of intermittent failures due to insufficient cooling. Constraints on the amount of power that can be delivered to server racks makes energy conservation critical for fully utilizing the available space on these racks.

Web servers typically process requests as soon as they are received. Accordingly, the processor and system resources cannot be placed in any power conservation state such as a hibernation mode. In addition, many data centers are characterized by request loading that varies widely with time. Because many data centers are designed to handle a specified peak load, there may be significant periods of time when the request loading is quite low. Therefore, it would be desirable to implement a system and method for conserving power in data centers when the loading justifies power conservation measures.

### SUMMARY OF THE INVENTION

The problems identified above are in large part addressed by a method and system according to the present invention in which client requests to a multi-server, local area network such as a data center are accumulated and stored during discrete time intervals (referred to herein as batching periods), but not processed immediately. The data center servers are initialized to a low power state in which power consumption is substantially lower than the server's operational power consumption. At the end of a batching period or upon occurrence of some other specified event, the data center selects one or more servers to process the requests accumulated during the batching period. The selected servers are then powered on and the requests are distributed to the powered servers for processing and response generation. After all requests have been responded to, the data center typically powers down the servers. In this manner, servers are actively powered only during the periods when batched requests are being processed. It is theorized that, during times when a data center's request loading is sufficiently light, the response periods will be significantly shorter than the batching periods. In this case, power consumption is reduced because the servers are fully powered only during the relatively short response periods. The data center typically includes a router or other suitable switching device that is capable of storing requests gathered during the batching periods and of distributing the requests to the selected servers after a batching period ends. Batching periods may terminate at the expiration of a specified duration or when the age of a pending request exceeds some predetermined level of responsiveness to which the data center adheres.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a data processing network according to one embodiment of the invention;

FIG. 2 is a block diagram of selected features of a server in the data processing network of FIG. 1;

FIG. 3 is a conceptualized illustration of network request and response processing according to one embodiment of the present invention; and

FIG. 4 is a flow diagram of a method of handling network requests in a data processing network according to an embodiment of the present invention.

FIG. 5 is a block diagram of selected features of the network of FIG. 1 emphasizing an embodiment in which the servers are partitioned into logical subsets.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the invention contemplates a data processing network and method in which client requests to a server cluster or data center are accumulated. During the periods when requests are being accumulated, the servers are placed in a power conservation state. When sufficient requests have been accumulated, or when a particular request has been pending for a specified period of time, the network will power-up one or more server systems and distribute the accumulated requests to the powered-up systems for processing. When the request processing is complete, the servers are returned to a power conservation state while more requests are accumulated. The accumulation of requests may be made by a network switch or router that is connected to each of the servers in the data center. This switch may operate without or without the aid of mass permanent storage devices such as magnetic disks. Especially when the request loading on the data center is comparatively light, request batching in the described manner can save substantial energy without a significant decrease in the response perceived by the requesters.

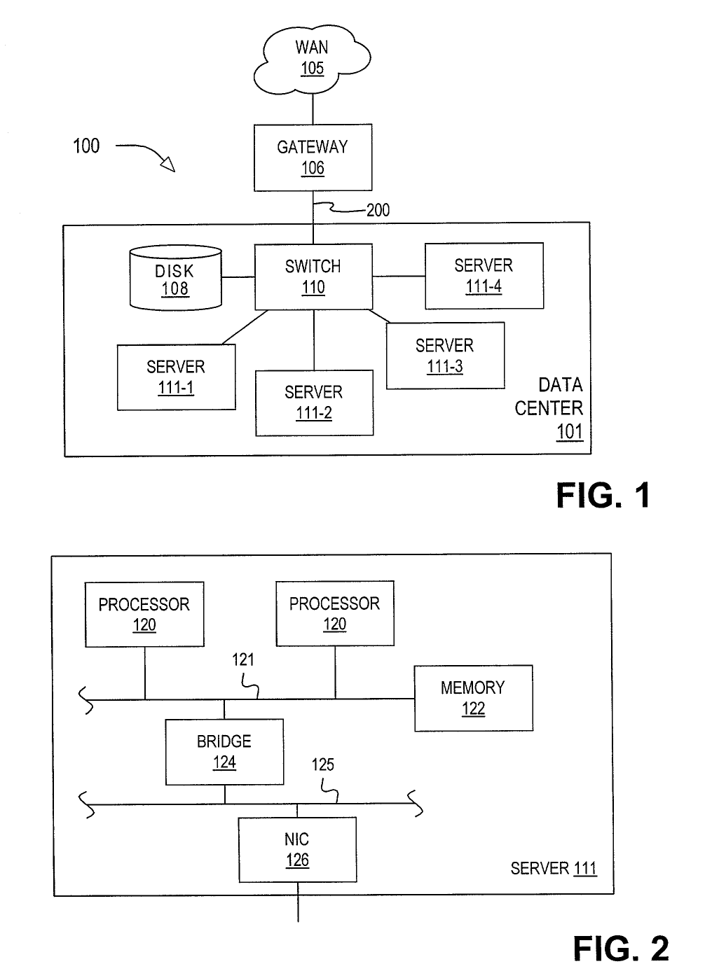

Turning now to the drawings, FIG. 1 is a block diagram illustrating selected features of a data processing network 100 according to one embodiment of the present invention. In the depicted embodiment, data processing network 100 includes a multi-server local area network 101 (LAN, also referred to herein as data center 101 or server cluster 101) that is connected to a wide area network (WAN) 105 through an intermediate gateway 106. WAN 105 may include a multitude of various network devices including gateways, routers, hubs, and so forth as well as one or more LANs all interconnected over a potentially widespread geographic area. WAN 105 may represent the Internet in one embodiment.

Server cluster 101 as depicted includes a central switch 110 that is connected to the gateway 106 via a network connection 200. Central switch 110 is typically implemented as a network router or other similar data processing device. In the depicted embodiment, central switch 110 is connected to or has access to a source of mass permanent storage in the form of disk 108 although other embodiments may exclude this feature. Server cluster 101 further includes a plurality of servers, four of which are depicted in FIG. 1 and indicated by reference numerals 111-1, 111-2, 111-3, and 111-4 (collectively or generically referred to as server(s) 111). Server cluster 101 may service all requests to a particular universal resource indicator (URI). In this embodiment, client requests to the URI that originate from anywhere within WAN 105 are routed to the cluster.

Switch 110 may include request distributor software that is responsible for routing client requests to one of the servers 111 in server cluster 101. The request distributor may incorporate any of a variety of distribution algorithms or processes to optimize the server cluster performance, minimize energy consumption, or achieve some other goal. Switch 110 may, for example, route requests to a server 111 based on factors such as the current loading of each server 111, the requested content, or the source of the request. The depicted embodiment of server cluster 101 illustrates a cluster configuration in which each server 111 is connected to switch 110 through a dedicated connection. In other embodiments, the server cluster may be implemented with a shared media configuration such as a conventional Ethernet or token ring configuration. In the switched embodiment depicted, each server 111 typically includes a network interface card and switch 110 includes a port for each server 111.

Referring now to FIG. 2, additional detail of an embodiment of server 111 is shown. Server 111 includes one or more general-purpose microprocessors 120 that are each connected to a system bus 121. Processors 120 may be implemented with commercially distributed microprocessors such as the PowerPC® family of processors from IBM Corporation, an x86-type processor such as the Pentium® family of processors from Intel, or some other suitable processor. Each processor 120 has access to the system memory 122 of server 111. System memory 122 is a volatile storage element typically implemented with a set of dynamic random access memory (DRAM) devices. Server 111 may further include a bus bridge 124 connected between a peripheral bus 125 and system bus 121. One or more peripheral devices are typically connected to peripheral bus 125. The depicted illustration of server 111 is shown as including a network interface card 126 connected to peripheral bus 125. In this embodiment, NIC 126 enables server 111 to connect to the network medium that connects the servers and any other network devices in server cluster 101.

In the network environment depicted in FIG. 1, client applications such as conventional web browsers generate client requests that are received by server cluster 101. The sum total of all client requests received by server cluster 101 represents the data center's request loading. This loading is typically non-uniform with respect to time. In other words, client requests arrive at server cluster 101 asymmetrically. During peak loading periods, it may well be that all servers 111 of server cluster 101 are required to operate at or near capacity to maintain an acceptable level of responsiveness. At other times, however, the request loading is likely to be substantially less than the peak load. Asymmetric request loading is characteristic of many commercial data centers. The present invention conserves power during periods of low activity by incorporating a request batching and power management technique that reduces power consumption during intervals when data center requests are being accumulated. Following each such accumulation period, one or more of the data center servers are powered up to process the requests. After the accumulated requests have been processed, the data center servers return to a low power state while a new set of requests are accumulated. During periods when the data center's request loading is relatively low, the disclosed method and system is effective in reducing data center power consumption.

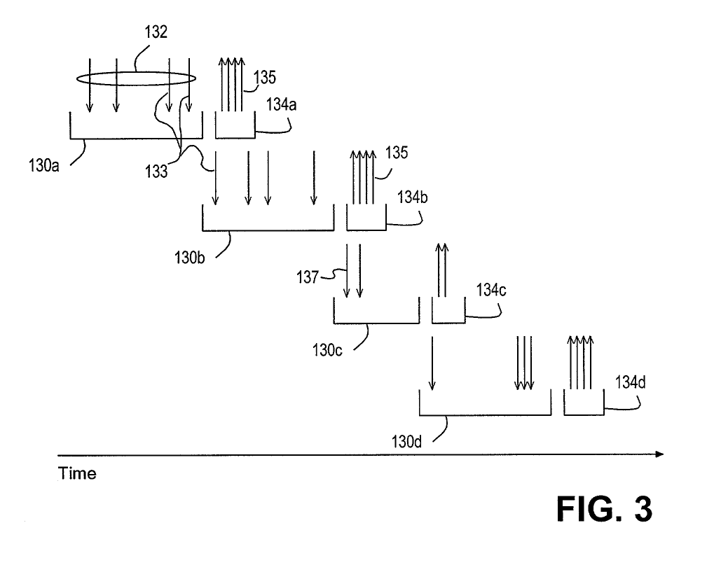

Returning to the drawings, FIG. 3 is a conceptualized illustration of a method by which a data processing network responds to a request workload according to one embodiment of the invention. In the depicted embodiment, the horizontal axis represents time, client requests received by server cluster 101 are represented by downward pointing arrows 133, and the corresponding responses generated by the data center are represented by upward pointing arrows. A client request is typically, though not always, a relatively small command to retrieve data such as a web page, a set of data records, or some other information from the data center. When a client enters the URL of a data center's home page on his or her web browser, for example, the browser generates an HTTP GET request that is sent to the data center. In this example, the data center responds by returning to the client the data that comprises the data center's home page. Typically, the request is relatively small relative to the corresponding responses. Similarly, in database applications, a relatively simple request to retrieve, sort, or do some other function on a database may generate a relatively large response. The HTTP GET request and the database request and their corresponding response are just examples of the client requests represented and data center responses represented by arrows 133 and 135 in FIG. 3. Those skilled in the field of data processing networks and network communications will appreciate that a wide variety of requests and responses are possible.

The invention reduces data center power consumption by dividing time into discrete periods referred to herein as accumulation periods or batching periods. These batching periods are indicated in FIG. 3 by reference numerals 130a through 130d (generically or collectively referred to as batching period(s) 130). According to the present invention, the data center is configured to batch or store requests received during a batching period 130 instead of processing the request(s) immediately. Server cluster 101 is configured to wait until the end of a batching period 130 (or until some other specified event occurs) before processing the requests received during the batching period. At the end of a batching period 130, all requests received during the batching period are then distributed to the data center's servers for processing. Processing periods (identified by reference numerals 134a through 134d) are shown in FIG. 3 corresponding to each batching period 130a through 130d.

In one embodiment, the data center servers 111 are initialized to a low power state such that all servers 111 are in a low power state during the initial batching period 130a. During this initial batching period 130a, a set of requests (identified by reference numeral 132a) is received and stored by server cluster 101. To facilitate the storage of requests 132a, server cluster 101 may use disk 108, which may comprise a local disk, a networked storage device, or some other form of mass permanent storage. In other embodiments, server cluster 101 may store the set of requests 132a entirely within the system (volatile) memory of switch 110. This embodiment is particularly feasible in the context of consumer web sites and the like where client requests (such as the HTTP GET request referred to above) tend to be relatively small in size.

Server cluster 101 is configured to detect the end of batching period 130a and to initiate processing of the set of requests 132a accumulated during batching period 130a when the end is detected. To accomplish the processing of requests 132a, server cluster 101 and, more particularly, switch 110 is configured to power on one or more servers 111 at the end of each batching period 130. The number of servers 111 that are powered on at the end of a batching period is implementation specific. In one embodiment, switch 110 may power on all servers 111 and distribute requests 132a to each of the servers 111 such that each server 111 is assigned a roughly equal proportion of the request load. In other embodiments, the number of servers powered up at the end of a batching period may vary depending upon factors including, as examples, the number of requests received during the period, the content requested, and the size of the responses required to satisfy each request. Thus, the number of servers 111 powered on after a response period 132 may be less than the total number of servers 111 in server cluster 101. In one notable embodiment, for example, the number of servers 111 powered on is the minimum number of servers required to process the request load within a specified time period where the specified time period represents some maximum time allocated for responding to a request load. This embodiment beneficially reduces power consumption during the processing phase under the theory that, due to power overhead associated with each server 111, it is more efficient to concentrate the load in fewer servers than to spread the load over more servers.

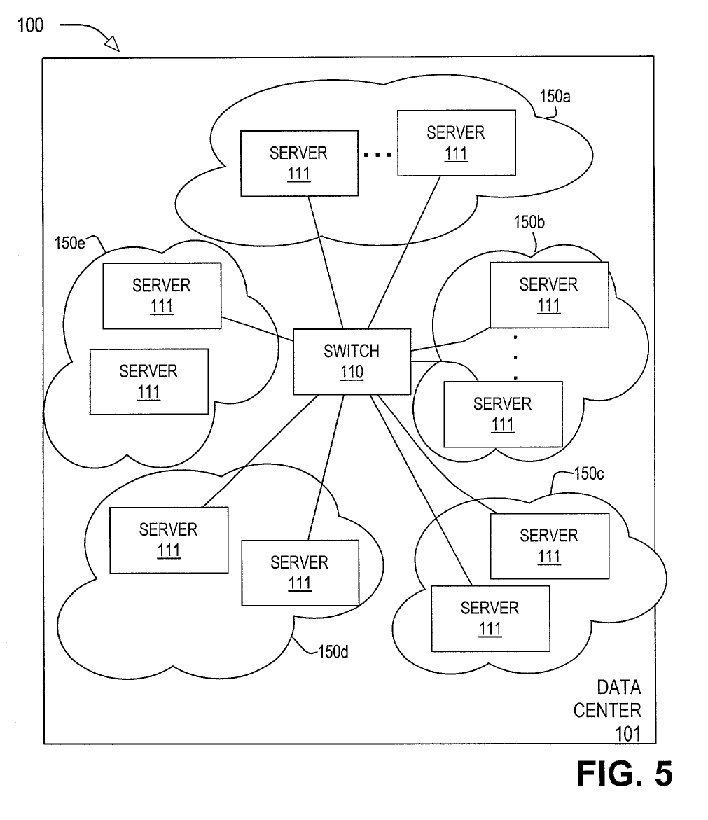

In one embodiment of the invention, the set of servers 111 are not implemented as functional equivalents of one another. In a staged request processing embodiment, for example, requests are processed in a sequence of discrete stages, which are typically separated by buffers or queues. The sequence of request processing stages might include, as examples, a reading stage, a parsing stage, a cache checking stage, a cache miss handling stage, and an data retrieving stage. As conceptually depicted in FIG. 5, the servers 111 in a staged request processing embodiment are logically partitioned into processing subsets 150a through 150e (generically or collectively referred to as processing subset(s) 150). The actual number of such subsets used in any one embodiment varies, of course, with implementation. Each subset 150 is responsible for a stage in the request processing sequence. Typically, the number of servers 111 is substantially larger than the number of stages such that each server subset includes multiple servers 111. Incorporating the teachings of the present invention into such an implementation is achievable by associating batching periods and response periods with each processing stage. During the response periods, server cluster 101 powers the minimum number of servers in each subset 150 required to process the batched requests within the time allotted.

After the servers selected by switch 110 to process the accumulated set of requests 132 are powered on, switch 110 distributes the requests to the powered servers for processing. It is theorized, particularly during periods of less than peak request loading, that the length of processing period 134, representing the amount of time required to process the set of requests 132 accumulated during the corresponding batching period 130, will be less than the length of the corresponding batching period 130. At the end of each processing period 134, when all accumulated requests have been responded to by servers 111, server cluster 101 is configured to return one or more and preferably all servers 111 to a low power state.

Server cluster 101 is preferably further configured to initiate a new batching period at the termination of the preceding batching period. Thus, for example, a second batching period 130b is initiated immediately following the termination of first batching period 130a. The second batching period 130b and the first response period 134a, which are both initiated at the end of first batching period 130a, overlap such that, for a portion of the second batching period 130b, switch 110 is processing the first set of requests 132a and generating the corresponding responses.

In one embodiment, a processing period 134 may be initiated by an event other than the expiration of the processing period 130. As an example, server cluster 101 may be configured to provide a minimum level of responsiveness for selected types of requests. If, for example, client requests consist of low priority requests that are presumably relatively common and high priority requests that are relatively rare, server cluster 101 may initiate a response period 134 before the expiration of the corresponding batching period 130 when a high priority request is received during the batching period. An example of this scenario is illustrated in the third batching period 130c of FIG. 3. During this batching period, a high priority request identified by reference numeral 137 is received relatively early in the response period. To guarantee a specified level of responsiveness for this request, server cluster 101 terminates the batching period prematurely and initiates a response period 134c. It will be appreciated that third batching period 130c is shorter than the other batching periods are. Thus, a batching period 130 may terminate at the expiration of a specified duration or when the age of a pending request exceeds some predetermined level of responsive to which the data center adheres.

Portions of the present invention may be implemented as a sequence of computer executable instructions (software) stored on a computer readable medium for receiving and responding to client requests in a data processing network. During execution of the instructions, portions of the software may be stored in a volatile storage element (memory) such as the system memory (DRAM) of switch 110 or an internal or external cache (SRAM) of a processor of switch 110. At other times, the instructions may be stored in a non-volatile storage element such as a hard disk, floppy diskette, ROM, CD ROM, DVD, magnetic tape, and the like.

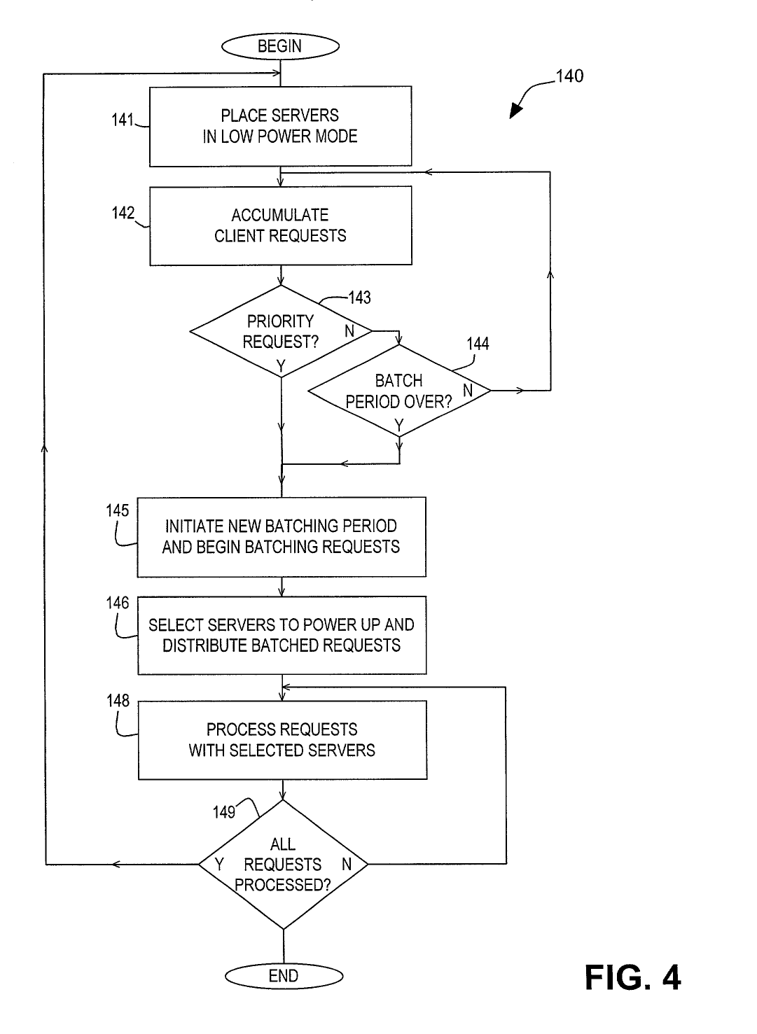

Referring now to FIG. 4, a flow diagram illustrating a method 140 of receiving and responding to client requests in a network environment according to one embodiment of the invention is depicted. In the depicted embodiment, the servers 111 of a server cluster 101 are initially placed (block 141) in a low power mode. Servers 111 of server cluster 101 preferably include power management facilities that enable each server 111 to exist in any of at least two power states including a full power state, wherein substantially all of the server's resources are powered, and a low power state, in which power is maintained only to essential resources such as system memory. Precise details of the available power states is implementation specific. Some servers, for example, may implement three or more power states. In any event, each implementation provides a low power state in which non-essential resources, including any peripheral devices connected to the system, are put into a low power state or shut down to reduce system power consumption.

Following the initialization of servers 111 to a low power state, method 140 includes initiating a batching period 130 during which client requests are received and stored or accumulated (block 142). In the depicted embodiment, server cluster 101 remains in the accumulation mode until either of two conditions occurs. A first condition that terminates the current batching period is the detection (block 143) of a high priority client request as described previously with respect to FIG. 3. The second condition that terminates the current batching period is the expiration (block 144) of a specified or predetermined duration. Thus, although a batching period typically expires at the end of a specified duration, a batching period may also be terminated prematurely to maintain a specified level of responsiveness.

When a batching period expires, the data center initiates (block 145) a new batching period then determines (block 146) which servers 111 are needed to generate appropriate responses for the accumulated requests. In an embodiment emphasizing performance, for example, all of the available servers may be selected to handle the accumulated requests. In other embodiments, less than all servers may be selected. For example, the minimum number of servers that can process the batch within the allocated time may be powered. In any event, the selected servers are then powered to a state in which they can process requests and generate responses. Following the selection powering of the servers needed to process the accumulated requests, a response period is initiated during which the selected servers process (block 148) the accumulated requests and generate corresponding responses. When all accumulated requests have been processed (block 149), the data center powers down the selected servers until the current batching period expires and the process repeats.

It will be apparent to those skilled in the art having the benefit of this disclosure that the present invention contemplates a method and system for conserving power when receiving and responding to client requests in a network environment. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A method of processing requests in a data processing network, comprising:
initializing a set of servers comprising at least a portion of a server cluster to a low power state;
receiving a set of client requests with the server cluster during a batching period;
at the termination of the batching period, selecting at least one of the servers to process the received requests and powering on the selected servers;
distributing the set of received requests to the powered servers and generating responses to the received requests; and
following generation of the responses, re-initializing the set of servers to the low power state.

2. The method of claim 1, wherein the batching period is terminated at the end of a predetermined duration.

3. The method of claim 1, wherein the batching period is terminated when a predetermined number of requests have been received.

4. The method of claim 1, wherein each request is associated with a priority level and wherein the batching period is terminated if the age of any of the received requests exceeds a predetermined limit corresponding to the priority level.

5. The method of claim 1, wherein selecting the servers to process the received requests includes determining a minimum number of servers required to process the accumulated requests within a specified duration and powering the selected severs.

6. The method of claim 1, further comprising partitioning the set of servers into a set of subgroups and processing the accumulated requests as a sequence of stages, wherein each of the server subgroups is responsible for a stage in the processing sequence.

7. The method of claim 6, wherein the number of servers powered in each of the server subgroups is the minimum number of servers required to process the requests in the corresponding stage of the processing sequence.

8. The method of claim 1, further comprising storing the received requests on a switch connected to each of the servers.

9. A server cluster suitable for processing requests, comprising:
a set of servers, each comprising a system memory, at least one processor connected to the system memory, an adapter suitable for connecting each server to a network;
a switch connected to the network, the switch including processor and a computer readable medium configured with instructions for processing network requests, the instructions including:
computer code means for initializing a set of servers comprising at least a portion of a server cluster to a low power state;
computer code means for receiving a set of client requests with the server cluster during a batching period;
computer code means for selecting, at the termination of the batching period, at least one of the servers to process the received requests and for powering on the selected servers;
computer code means for distributing the set of received requests to the powered servers and generating responses to the received requests; and
computer code means for re-initializing the selected servers to the low power state following generation of the responses.

10. The server cluster of claim 9, wherein the batching period is terminated at the end of a predetermined duration.

11. The server cluster of claim 9, wherein the batching period is terminated when a predetermined number of requests have been received.

12. The server cluster of claim 9, wherein each request is associated with a priority level and wherein the batching period is terminated if the age of any of the received requests exceeds a predetermined limit corresponding to the priority level.

13. The server cluster of claim 9, wherein selecting the servers to process the received requests includes determining a minimum number of servers required to process the accumulated requests within a specified duration and powering the selected severs.

14. The server cluster of claim 9, further comprising partitioning the set of servers into a set of subgroups and processing the accumulated requests as a sequence of stages, wherein each of the server subgroups is responsible for a stage in the processing sequence.

15. The server cluster of claim 14, wherein the number of servers powered in each of the server subgroups is the minimum number of servers required to process the requests in the corresponding stage of the processing sequence.

16. The server cluster of claim 9, further comprising storing the received requests on a switch connected to each of the servers.

17. A computer program for processing requests in a server cluster comprising a set of servers connected via a network medium to a switch, comprising:
computer code means for initializing a set of servers comprising at least a portion of a server cluster to a low power state;
computer code means for receiving a set of client requests with the server cluster during a batching period;
computer code means for selecting, at the termination of the batching period, at least one of the servers to process the received requests and for powering on the selected servers;
computer code means for distributing the set of received requests to the powered servers and generating responses to the received requests; and
computer code means for re-initializing the selected servers to the low power state following generation of the responses.

18. The computer program product of claim 17, wherein the batching period is terminated at the end of a predetermined duration.

19. The computer program product of claim 17, wherein the batching period is terminated when a predetermined number of requests have been received.

20. The computer program product of claim 17, wherein each request is associated with a priority level and wherein the batching period is terminated if the age of any of the received requests exceeds a predetermined limit corresponding to the priority level.

21. The computer program product of claim 17, wherein selecting the servers to process the received requests includes determining a minimum number of servers required to process the accumulated requests within a specified duration and powering the selected severs.

22. The computer program product of claim 17, further comprising partitioning the set of servers into a set of subgroups and processing the accumulated requests as a sequence of stages, wherein each of the server subgroups is responsible for a stage in the processing sequence.

23. The computer program product of claim 22, wherein the number of servers powered in each of the server subgroups is the minimum number of servers required to process the requests in the corresponding stage of the processing sequence.

24. The computer program product of claim 17, further comprising storing the received requests on a switch connected to each of the servers.
